(19) United States
(12) Patent Application Publication
(10) Pub. No.: US 2012/0153131 A1
(43) Pub. Date: Jun. 21, 2012

(54) SOLID-STATE IMAGE PICKUP DEVICE

(75) Inventors: HISATO ISHIMOTO, Hyogo (JP); YUTAKA ABE, Osaka (JP)

(73) Assignee: PANASONIC CORPORATION, Osaka (JP)

(21) Appl. No.: 13/409,389

(22) Filed: Mar. 1, 2012

Related U.S. Application Data
(63) Continuation of application No. PCT/JP2010/005031, filed on Aug. 11, 2010.

(30) Foreign Application Priority Data
Sep. 7, 2009 (JP) 2009-205635

(51) Int. Cl. H01L 27/146

(52) U.S. Cl. 250/208.1

(57) ABSTRACT

A solid-state image pickup device includes: plural pixel cells that are two-dimensionally arrayed, the pixel cell including a photoelectric conversion element and an amplification transistor; plural vertical signal lines; at least two reference current source circuits that includes a reference transistor; and plural load transistors each of which is connected to the vertical signal line, the load transistor constituting a current mirror in conjunction with the reference transistor. The load transistor and the reference transistor are grounded to a common ground line in different positions, and, in at least two position, a distance between connection points at which the load transistor and the reference transistor, which constitute the current mirror, are grounded to the ground line is shorter than a distance between connection points of the load transistors adjacent to each other on the ground line.

### BACKGROUND

1. Technical Field

The present invention relates to a solid-state image pickup device, particularly to a MOS solid-state image pickup device that amplifies and outputs a signal charge to which photoelectric conversion has been performed.

2. Background Art

Recently, in many places in the world, development of a MOS (Metal Oxide Semiconductor) solid-state image pickup device is actively made as a solid-state image pickup device suitable for a camcorder, a digital still camera, and the like. The solid-state image pickup device is configured such that the signal charge to which the photoelectric conversion has been performed by a photoelectric conversion element is amplified by a transistor and taken out in each cell.

FIG. 10 is a block diagram illustrating a configuration of a conventional solid-state image pickup device described in Unexamined Japanese Patent Publication No. 2001-230974. The solid-state image pickup device includes image pickup unit 1, vertical scanning circuit 2 that performs vertical scanning, vertical signal lines V1 to V3, clipping circuits 3a to 3c that output clipping voltages to vertical signal lines V1 to V3, load transistors M51 to M53 that are of an NMOS transistors (hereinafter referred to as a “transistor) connected to vertical signal lines V1 to V3, respectively, GND line 4, voltage input terminal 5, control line 6, power supply line 7, reference current source circuit 8, CDS circuit 9, and horizontal scanning circuit 10.

In image pickup unit 1, pixel cells 110 to 330 are two-dimensionally arrayed. The pixel cells (110 to 130, 210 to 230, and 310 to 330) of each column are commonly connected to the vertical signal line corresponding to the column in vertical signal lines V1 to V3, and the pixel cells (110 to 310, 120 to 320, and 130 to 330) of each row are commonly connected to the row selection line and a reset line corresponding to the row in row selection lines SEL1 to SEL3 connected to vertical scanning circuit 2 and reset lines RST1 to RST3.

Each pixel cell includes a photodiode, a reset transistor that resets a charge of the photodiode, an amplification transistor that amplifies a signal charge accumulated in the photodiode, and a selection transistor that selects the row.

The reference marks D11 to D33 designate the photodiode included in each pixel cell, the marks M211 to M233 designate the reset transistor included in each pixel cell, the marks M311 to M333 designate the amplification transistor included in each pixel cell, and the marks M411 to M433 designate the selection transistor included in each pixel cell.

Each of load transistors M51 to M53 constitutes a load of the amplification transistor connected to the vertical signal line common to the load transistor. A drain of each of load transistors M51 to M53 is connected to the corresponding vertical signal line. Reference transistor M50 is included in reference current source circuit 8 to constitute a current mirror in conjunction with each of load transistors M51 to M53, and reference transistor M50 becomes a reference in order to set a constant current that is fed through voltage input terminal 5 and passed through each of load transistors M51 to M53. Sources of reference transistor M50 and load transistors M51 to M53 are commonly connected to GND line 4.

Sources of the amplification transistors of the pixel cells of each column are commonly connected to the corresponding vertical signal line of the column, and the amplification transistor constitutes a source follower circuit in conjunction with the load transistor connected to the vertical signal line common to the amplification transistor, and outputs to the vertical signal line a signal voltage (Vx) corresponding to the signal charge generated by the photodiode of the pixel cell including the amplification transistor.

Clipping circuit 3a includes clipping transistor M71 that clips a voltage at vertical signal line V1 to a constant clipping voltage such that the voltage at vertical signal line V1 does not become a predetermined voltage or less and clipping connection transistor M81 that connects clipping transistor M71 to vertical signal line V1.

In clipping transistor M71, a source is connected to vertical signal line V1, a gate is connected to power supply line 7 that sets the clipping voltage, and a drain is connected to the a source of clipping connection transistor M81. A gate of clipping connection transistor M81 is connected to control line 6 that is used to control a clipping operation. Clipping circuits 3b and 3c have the same configuration as clipping circuit 3a.

On the vertical signal line to which the source of each of clipping transistor M71 to M73 of clipping circuits 3a to 3c is connected, the source is connected to the source of the amplification transistor of each pixel cell to constitute a differential configuration.

Specifically, when the gate voltage of the amplification transistor is sufficiently higher than the clipping voltage applied to the gate of the clipping transistor of the clipping circuit, because the clipping transistor is turned off, the signal voltage (Vx) is read through the amplification transistor on the vertical signal line relating to each clipping circuit according to the gate voltage of the amplification transistor. When the gate voltage of the amplification transistor is decreased to come close to the clipping voltage, the clipping transistor corresponding to the amplification transistor is turned on such that the signal voltage (Vx) of the vertical signal line does not become the clipping voltage or less even if the gate voltage of the amplification transistor becomes the clipping voltage or less.

An operation of the conventional solid-state image pickup device of FIG. 10 will be described below. When receiving the light, each of photodiodes D11 to D33 in the pixel cells generates and accumulates signal charge. The accumulated signal charges are amplified in each row of the pixel cells by the amplification transistor of the pixel cell while vertically scanned by vertical scanning circuit 2, and the signal charge is read as the signal voltage (Vx) on the vertical signal line to which the source of the amplification transistor is connected.

When the first row is selected, the signal of row selection line SEL1 to which the gates of selection transistors M411 to M431 are connected becomes the high level to activate amplification transistors M311 to M331. Therefore, the signal charges of pixel cells 110 to 310 of the first row are amplified by amplification transistors M311 to M331, and read as the signal voltages (Vx) on vertical signal lines V1 to V3.

Then the signal of row selection line RST1 to which each of the gates of selection transistors M211 to M231 is connected becomes the high level to reset the signal charge accumulated in each of photodiodes D11 to D31.

Then, pixel cells 120 to 320 of the second row are selected, similarly the signal charge of each pixel cell of the second row is amplified and read as the signal voltage (Vx) on each of vertical signal lines V1 to V3. Similarly, in the rows from the third row, the signal voltages (Vx) are read on vertical signal lines V1 to V3.

The amount of signal charge accumulated in the photodiode is increased with increasing amount of light received by the photodiode, a gate potential of the amplification transistor whose gate is connected to the photodiode is decreased from a potential during reset according to the increase in signal charge amount, and the signal voltage (Vx) output from the amplification transistor to the vertical signal line is decreased according to the decrease in gate potential of the amplification transistor.

Because vertical signal lines V1 to V3 are connected to the drains of the corresponding load transistors, the signal voltage (Vx) read from the pixel cell is largely decreased in the vertical signal line connected to the pixel cell that receives light having extremely high illuminance, a drain-source voltage (hereinafter referred to as “Vds”) of the load transistor connected to the vertical signal line becomes 0 V to turn off the load transistor, and the current is not passed between the drain and the source of the load transistor.

Because the sources of load transistors M51 to M53 are commonly connected to GND line 4, when the load transistor connected to one of the vertical signal lines is turned off while the signal voltages (Vx) of the pixel cells of a certain row are read onto vertical signal lines V1 to V3, the amount of current flowing in GND line 4 is decreased by the amount of current that is not passed through the turned-off load transistor, thereby decreasing an amount of voltage drop caused by an interconnection impedance of GND line 4.

The potential on the source side of the load transistor, which is connected to GND line 4 and not turned off, is decreased by the decrease of the voltage drop amount on GND line 4, while the potential on the gate side of the load transistor does not vary. Therefore, a gate-source voltage of the load transistor that is not turned off is increased by the amount of decrease in potential on the source side, and according to this, an amount of current passed between the drain and the source of the load transistor increases and Vds of the load transistor is decreased.

For example, when spot light having such extremely high illuminance that the load transistor is turned off is incident to the solid-state image pickup device, the signal voltages (Vx) of the pixel cells, to which lights are not originally incident and which are located on the right and left of the pixel cell to which the spot light is incident, are detected lower than the original values. As a result, unfortunately whitish bands are generated on the right and left of the spot light in a captured image of the spot light.

In the conventional solid-state image pickup device of FIG. 10, clipping circuits 3a to 3c are provided in order to solve the problem, the voltage at each of vertical signal lines V1 to V3 is clipped at a constant voltage so as not to become a predetermined voltage or less, and Vds of the load transistor of the vertical signal line to which the pixel cell is connected does not becomes 0 V to turn off the load transistor even if the spot light having the extremely high illuminance is incident to the pixel cell.

Therefore, the variation of the amount of voltage drop caused by the interconnection impedance of GND line 4 is eliminated to prevent the variation of amount of current passed through the load transistor that is not turned off, and the generation of the whitish band can be prevented on the right and left of the spot light in the captured image even if the spot light having the extremely high illuminance is incident to the pixel cell.

### SUMMARY

### Problems to be Solved

In the conventional art, because the clipping voltage is set so as not become a minimum voltage (a boundary value of a lower limit on a saturation region) at which load transistors M51 to M53 are operated in the saturation region, clipping circuits 3a to 3c are turned off and disabled in the saturation region where Vds becomes the minimum voltage or more.

On the other hand, when Vds of the load transistor exists in the saturation region, the amount of current passed between the drain and the source of the load transistor is gradually decreased by a channel length modulation effect as Vds is decreased. Therefore, when the many pixel cells to which the spot light having the illuminance that the detected signal voltage becomes close to the minimum voltage are included in the row of the selected pixel cell, the amount of the decrease of current passed between the drain and the source of the load transistor that is connected to the pixel cell through the vertical signal line is increased by the channel length modulation effect.

As a result, the amount of current flowing in GND line 4 is decreased, and the amount of voltage drop caused by the interconnection impedance of GND line 4 is decreased, which results in a problem in that the whitish band is generated on the right and left of the spot light in the captured image for the same reason as the case in which the load transistor is turned off.

In the conventional art, because the signal voltage (Vx) read from the pixel cell is set by clipping circuits 3a to 3c so as not become the minimum voltage or less, unfortunately a dynamic range of the signal voltage read from the pixel cell is narrowed to decrease detection sensitivity on the high illuminance side.

In view of the foregoing, an object of the invention is to provide a solid-state image pickup device that can prevent the whitish band from being generated on the right and left of the spot light without narrowing the dynamic range of the signal voltage in the image to which the spot light having high illuminance is incident.

### Means for Solving the Problems

According to an embodiment of the invention, a solid-state image pickup device includes: plural pixel cells that are two-dimensionally arrayed, the pixel cell including a photoelectric conversion element that generates a signal charge according to a light receiving amount and an amplification transistor that amplifies and outputs the generated signal charge as a signal voltage; plural vertical signal lines to each of which outputs of the pixel cells of each identical column are commonly connected; at least two reference current source circuits that are connected to a constant-current source, the reference current source circuit including a reference transistor that receives supply of a constant current from the constant-current source; and plural load transistors each of which is connected to the vertical signal line of each column, a gate of each load transistor being connected to a gate of the reference transistor included in one of the reference current source circuits, the load transistor constituting a current mirror in conjunction with the reference transistor. In the solid-state image pickup device, the load transistor and the reference transistor, which are connected to the vertical signal line of each column, are grounded to a common ground line in different positions, and, in at least two position, a distance between connection points at which the load transistor and the reference transistor, which constitute the current mirror, are grounded to the ground line is shorter than a distance between connection points of the load transistors adjacent to each other on the ground line.

In a preferred embodiment, the reference current source circuits are provided for each load transistor connected to the vertical signal line of each column, and a distance between connection points at which the reference transistor included in the reference current source circuit and the load transistor are grounded to the ground line is shorter than the distance between the connection points of the load transistors adjacent to each other on the ground line.

In a preferred embodiment, a power feeding selector switch that switches between a turn-on and a turn-off of power feeding is provided in a predetermined reference current source circuit of the reference current source circuits in order to pass a constant current to each of the reference transistors of the reference current source circuits except the predetermined reference current source circuit, a first selector switch and a second selector switch are provided in each of the reference current source circuits except the predetermined reference current source circuit, the first selector switch switching between a turn-on and a turn-off of connection of the gate of the reference transistor of the reference current source circuit and the gate of the load transistor that constitutes the current mirror in conjunction with the reference transistor, the second switch switching between a turn-on and a turn-off of connection of the gate of the load transistor and the gate of the reference transistor of the predetermined reference current source circuit, the solid-state image pickup device includes: a first control signal line that is commonly connected to the power feeding selector switch and the first selector switches to turn on or off all the power feeding selector switch and the first selector switches; and a second control signal line that is commonly connected to the second selector switches to turn on or off the second selector switches, and the switching can be performed in all the selector switches using the first and second control signal lines.

In a preferred embodiment, the reference current source circuit is provided in each predetermined number of vertical signal lines with respect to the load transistor connected to the vertical signal line, and the distance between the connection points at which the reference transistor included in the reference current source circuit and the load transistor are grounded to the ground line is shorter than the distance between the connection points of the load transistors adjacent to each other on the ground line.

### Effects of the Invention

According to the above configuration, for the load transistor in which the distance between the connection points at which the reference transistor and the load transistor, which constitute the current mirror, are grounded to the ground line is shorter than the distance between the connection points of the load transistors adjacent to each other on the ground line, because of the short interconnection distance between the connection points and the small interconnection impedance of the interconnection distance, the current having the substantially same magnitude as the constant current supplied from the constant-current source to the reference transistor can be passed through the load transistor while the load transistor is hardly influenced by the interconnection impedance of the ground line.

When the load transistor connected to the pixel cell to which the spot light having the high illuminance is incident through the vertical signal line is turned off, or when the amount of current passed through the load transistor is decreased by the channel length modulation effect, the amount of current flowing in the ground line is decreased to decrease the amount of voltage drop caused by the interconnection impedance on the ground line. In such cases, the amount of current passed through the load transistor, in which the distance between the connection points at which the reference transistor and the load transistor, which constitute the current mirror, are grounded to the ground line is shorter than the distance between the connection points of the load transistors adjacent to each other on the ground line, hardly varies, the drain-source voltage of the load transistor is kept constant to effectively prevent the generation of the whitish band on the right and left of the spot light in the captured image, which is caused by the decrease in the drain-source voltage.

Additionally, in the above configuration, because it is not performed that the voltage at the vertical signal line is clipped at the constant voltage so as not to become a predetermined voltage or less, the dynamic range of the signal voltage is not narrowed.

### BRIEF DESCRIPTION OF DRAWINGS

FIG. 1 is a block diagram illustrating a configuration of a solid-state image pickup device according to a first exemplary embodiment.

FIG. 2 is a block diagram illustrating a configuration of a solid-state image pickup device according to a first modification of the first exemplary embodiment.

FIG. 3 is a block diagram illustrating a configuration of a solid-state image pickup device according to a second modification of the first exemplary embodiment.

FIG. 4 is a block diagram illustrating a configuration of a solid-state image pickup device according to a third modification of the first exemplary embodiment.

FIG. 5 is a block diagram illustrating a configuration of a solid-state image pickup device according to a fourth modification of the first exemplary embodiment.

FIG. 6 is a block diagram illustrating a configuration of a solid-state image pickup device according to a second exemplary embodiment.

FIG. 7 is a view for explaining a specific example of an operation of the solid-state image pickup device of the first exemplary embodiment.

FIG. 8 is a view illustrating a correspondence relationship between Vds and Ids.

FIG. 9 is a view for explaining a specific example of an operation of a solid-state image pickup device according to a comparative example.

FIG. 10 is a block diagram illustrating a configuration of a conventional solid-state image pickup device.

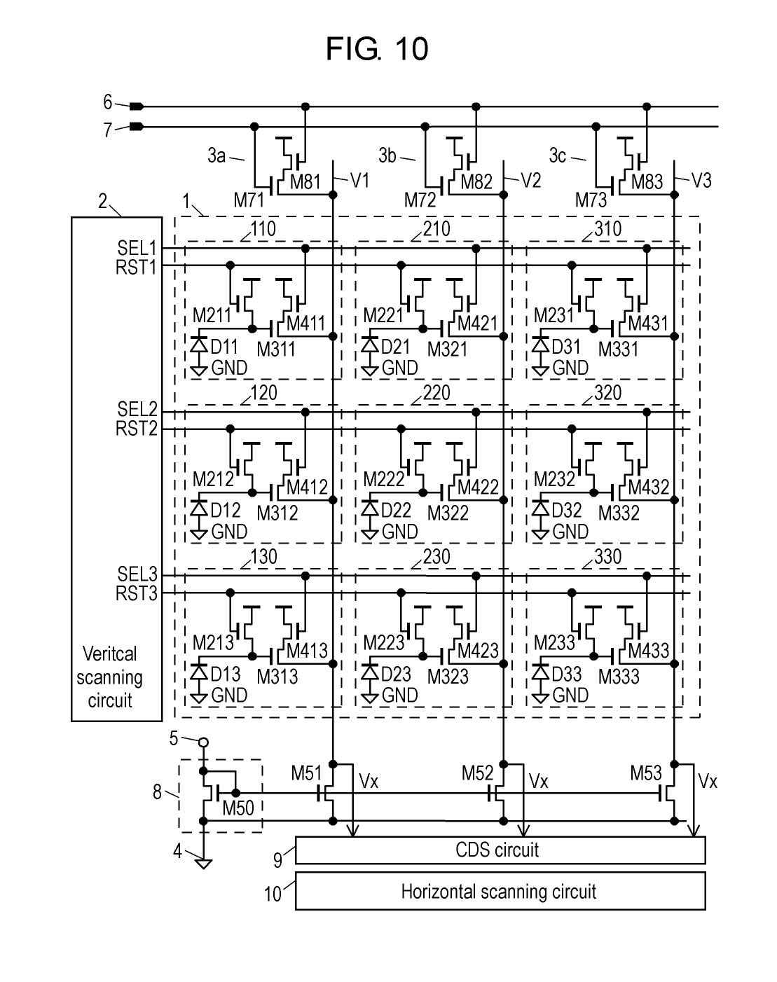

### DESCRIPTION OF EMBODIMENTS

Hereinafter, exemplary embodiments of the invention will be described with reference to the drawings. In the following exemplary embodiments, for example, it is assumed that each circuit element constituting the solid-state image pickup device is formed on one semiconductor substrate such as single-crystal silicon by a semiconductor integrated circuit producing technique. However, the invention is not limited to the exemplary embodiment. In the following exemplary embodiment, a 3-by-3 pixel array is described for the sake of convenience. However, the invention is not limited to the exemplary embodiment. In the following exemplary embodiment, an NMOS transistor is simply referred to as a “transistor”.

In the following exemplary embodiment, the same component as the conventional solid-state image pickup device is designated by the same reference mark.

### First Exemplary Embodiment

### Configuration

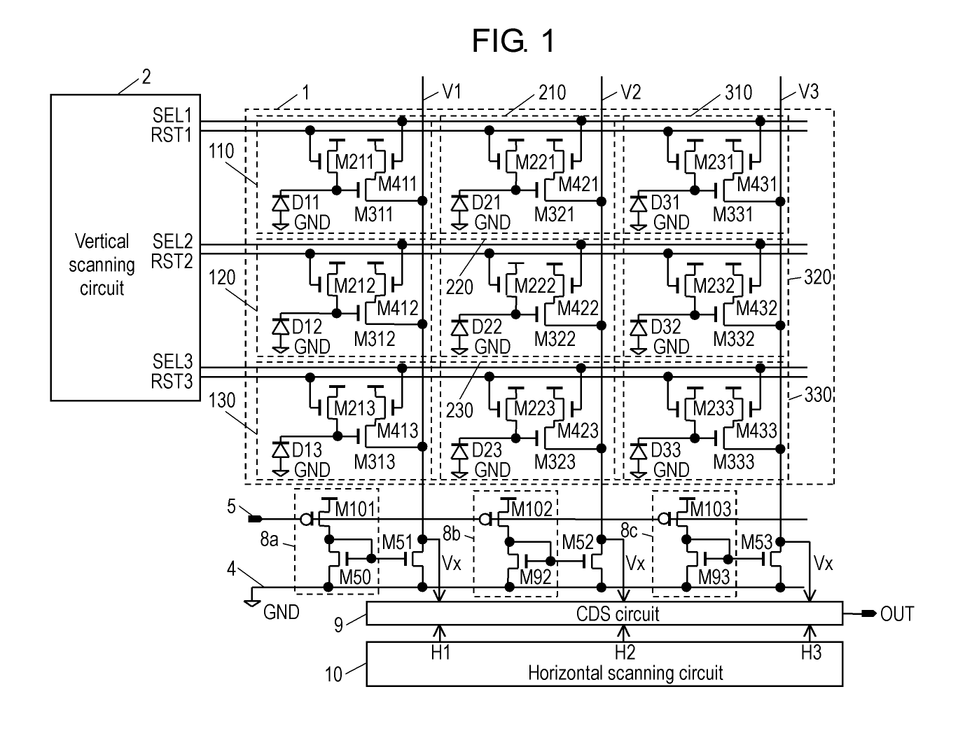

FIG. 1 is a block diagram illustrating a configuration of a solid-state image pickup device according to a first exemplary embodiment. Referring to FIG. 1, the solid-state image pickup device of the first exemplary embodiment includes image pickup unit 1, vertical scanning circuit 2 that performs vertical scanning, vertical signal lines V1 to V3, load transistors M51 to M53 in which drains are connected to vertical signal lines V1 to V3, respectively, GND line 4, voltage input terminal 5, reference current source circuits 8a to 8c, CDS circuit 9, and horizontal scanning circuit 10.

In image pickup unit 1, pixel cells 110 to 330 are two-dimensionally arrayed. The pixel cells (110 to 130, 210 to 230, and 310 to 330) of each column are commonly connected to the vertical signal line corresponding to the column in vertical signal lines V1 to V3, and the pixel cells (110 to 310, 120 to 320, and 130 to 330) of each row are commonly connected to the row selection line and a reset line corresponding to the row in row selection lines SEL1 to SEL3 connected to vertical scanning circuit 2 and common reset lines RST1 to RST3.

Each pixel cell includes a photodiode, a reset transistor that resets a charge of the photodiode, an amplification transistor that amplifies a signal charge accumulated in the photodiode, and a selection transistor that selects the row.

The reference marks D11 to D33 designate the photodiode included in each pixel cell, the reference marks M211 to M233 designate the reset transistor included in each pixel cell, the reference marks M311 to M333 designate the amplification transistor included in each pixel cell, and the reference marks M411 to M433 designate the selection transistor included in each pixel cell.

In each of amplification transistors M311 to M333, a source is connected to the vertical signal line, a gate is connected to a cathode side of the photodiode of the pixel cell including the amplification transistor and a source of the reset transistor of the pixel cell, and a drain is connected to a source of the selection transistor of the pixel cell.

Each amplification transistor constitutes a source follower circuit in conjunction with the load transistor connected to the vertical signal line common to the amplification transistor, and outputs a signal voltage (Vx) corresponding to the signal charge generated by the corresponding photodiode to the vertical signal line.

Each of load transistors M51 to M53 constitutes a load of the amplification transistor connected to the vertical signal line common to the load transistor. In each of load transistors M51 to M53, a source is connected to the GND line 4, a gate is connected to a gate of a reference transistor included in the corresponding reference current source circuit in reference current source circuits 8a to 8c, and a drain is connected to the corresponding vertical signal line.

Because each of reference current source circuits 8a to 8c includes the same components, reference current source circuit 8a will mainly be described below. Reference current source circuit 8a includes reference transistor M50 and PMOS transistor M101.

In PMOS transistor M101, a source is connected to a constant voltage source, a gate is connected to voltage input terminal 5, a drain is connected to a gate and a drain of reference transistor M50, and a constant voltage is supplied to the gate from voltage input terminal 5 to pass a constant current to reference transistor M50.

In reference transistor M50, a source is connected to GND line 4, the gate is connected to the gate of load transistor M51 and the drain of PMOS transistor M101, and the drain is connected to the drain of PMOD transistor M101.

Reference transistor M50 and load transistor M51 constitute a current mirror, and are disposed such that a distance between connection points in which reference transistor M50 and load transistor M51 are connected to GND line 4 becomes a neighborhood distance.

As used herein, the “neighborhood distance” means a distance that is larger than zero and shorter than each distance between the connection points adjacent to each other in the connection points in which each load transistors M51 to M53 is connected to GND line 4. Preferably, from the viewpoint of reducing an influence of an interconnection impedance of GND line 4 as small as possible, the distance between the connection points in which reference transistor M50 and load transistor M51 are connected to GND line 4 is a distance as close to zero as possible.

Similarly, reference current source circuit 8b includes reference transistor M92 and PMOS transistor M102, and reference current source circuit 8c includes reference transistor M93 and PMOS transistor M103.

Reference transistor M92 and load transistor M52 constitute the current mirror, and are disposed such that the distance between connection points in which reference transistor M92 and load transistor M52 are connected to GND line 4 becomes the neighborhood distance.

Similarly, reference transistor M93 and load transistor M53 constitute the current mirror, and are disposed such that the distance between connection points in which reference transistor M93 and load transistor M53 are connected to GND line 4 becomes the neighborhood distance.

CDS (Correlated Double Sampling) circuit 9 performs correlated double sampling by sampling and holding the signal voltages (Vx) read on vertical signal lines V1 to V3.

As used herein, the “correlated double sampling” means processing, in which two voltage signals (a voltage signal read on each of vertical signal lines V1 to V3 during reset and a voltage signal read on the vertical signal line in reading the signal voltage generated by the photodiode) input in time series are sampled, and a difference between the voltage signals is detected and output as a signal voltage caused by the signal charge,

Each detected signal voltage is output from horizontal scanning circuit 10. As timing signals H1 to H3 indicating output timing of the signal voltage sequentially become a high level, the corresponding signal voltage is output to the outside.

### <Operation>

An operation of the solid-state image pickup device of the first exemplary embodiment will be described below.

When receiving the light, each of photodiodes D11 to D33 in the pixel cells of FIG. 1 generates and accumulates signal charge according to an amount of received light. The accumulated signal charges are amplified in each row by the corresponding amplification transistor while vertically scanned by vertical scanning circuit 2, and the signal charges are read as the signal voltages (Vx) on vertical signal lines V1 to V3.

When the first row is selected, the signal of row selection line SEL1 to which the gates of selection transistors M411 to M431 are connected becomes the high level to turn on amplification transistors M311 to M331. Therefore, the signal charge accumulated by the photodiode of each of the pixel cells of the first row is amplified by the amplification transistor of the pixel cell, and read as the signal voltage (Vx) on the vertical signal line connected to the amplification transistor. Then the signal of row selection line RST1 to which each of the gates of reset transistors M211 to M231 is connected becomes the high level to reset the signal charge accumulated in the photodiode of each pixel cell of the first row.

Then, the second row is selected, similarly the signal charge accumulated by the photodiode of each pixel cell of the second row is amplified by the amplification transistor of the pixel cell, and read as the signal voltage (Vx) on the vertical signal line connected to the amplification transistor. Similarly, in the rows from the third row, the signal voltages (Vx) are read on the vertical signal lines.

At this point, when the spot light having the extremely high illuminance is incident to the pixel cell of one of the rows, the signal voltage (Vx) output from the pixel cell is largely decreased to 0 V in the vertical signal line connected to the pixel cell. Therefore, because a drain-source voltage (hereinafter referred to as “Vds”) of the load transistor connected to the vertical signal line becomes 0 V, the load transistor is turned off. When the load transistor is turned off, the current is not passed between the drain and the source of the load transistor, and an amount of current flowing in GND line 4 is decreased by the amount of current that is not passed through the turned-off load transistor, thereby reducing the amount of voltage drop caused by the interconnection impedance of GND line 4.

On the other hand, each of load transistors M51 to M53 is connected to the corresponding reference current source circuit. In the PMOS transistor of each reference current source circuit, the gate and the source are connected to the different constant voltage source such that a constant voltage is supplied between the gate and the source. Therefore, the constant voltage is supplied between the gate and the source of the PMOS transistor irrespective of the existence or non-existence of a variation of the voltage drop amount on GND line 4, and a current (hereinafter referred to as a “constant current”) corresponding to the constant voltage is passed between the source and drain of the PMOS transistor. The constant current is also passed between the drain and the source of the reference transistor to whose drain the drain of the PMOS transistor is connected irrespective of the existence or non-existence of the variation of the voltage drop amount on GND line 4, and the voltage does not vary between the gate and the source of the reference transistor.

Because each reference transistor and the load transistor corresponding to the reference transistor constitute the current mirror, when the gate-source voltage of each reference transistor is equal to the gate-source voltage of the load transistor corresponding to the reference transistor, the constant current can be passed between the drain and the source of the load transistor irrespective of the existence or non-existence of the variation of the voltage drop amount on GND line 4.

At this point, the gates of each reference transistor and the load transistor corresponding to the reference transistor are connected to each other, and a micro amount of current is passed between the gates. Therefore, it is considered that the amount of voltage drop caused by the interconnection impedance of the connection line between the gates is substantially equal to zero, and it is considered that potentials at the gates are equal to each other.

In the solid-state image pickup device of the first exemplary embodiment, because a certain amount of current is passed through GND line 4, a difference between the potentials at the sources of each reference transistor and the load transistor is increased according to the distance between the connection points on GND line 4 by the influence of the voltage drop caused by the interconnection impedance. However, because the distance between the connection points on GND line 4 is configured so as to become the neighborhood distance, the potential difference between the sources of each reference transistor and the load transistor can be decreased. Particularly the potential difference between the sources can be eliminated by setting the distance between the connection points to the distance in which the interconnection impedance substantially becomes zero.

As a result, the difference between the voltage between the gate and the source of each reference transistor and the voltage between the gate and the source of the load transistor corresponding to the reference transistor is decreased, and substantially same magnitude of current as the constant current is substantially passed through the corresponding load transistor irrespective of the influence of the variation of the voltage drop amount on GND line 4.

When the pixel cell to which the light having the high illuminance is incident exists in one of the rows, the load transistor connected to the pixel cell through the vertical signal line is turned off, or the amount of current passed through the load transistor is decreased by the channel length modulation effect and the amount of current flowing in GND line 4 is decreased to decrease the amount of voltage drop caused by the interconnection impedance on GND line 4. In such cases, according to the solid-state image pickup device of the first exemplary embodiment, the currents having the same magnitude as the constant currents are passed between the drains and the sources of the load transistors except the load transistor in question. Therefore, advantageously few amounts of current between the source and the drain varies, and the decrease in Vds of the load transistor, caused by the variation in current between the source and the drain, can be prevented, and the whitish band can effectively be prevented from being generated on the right and left of the spot light in the captured image.

In the solid-state image pickup device of the first exemplary embodiment, because it is not performed that the voltage at each of vertical signal lines V1 to V3 is clipped at the constant voltage so as not to become a predetermined voltage or less, advantageously the dynamic range of the signal voltage is not narrowed.

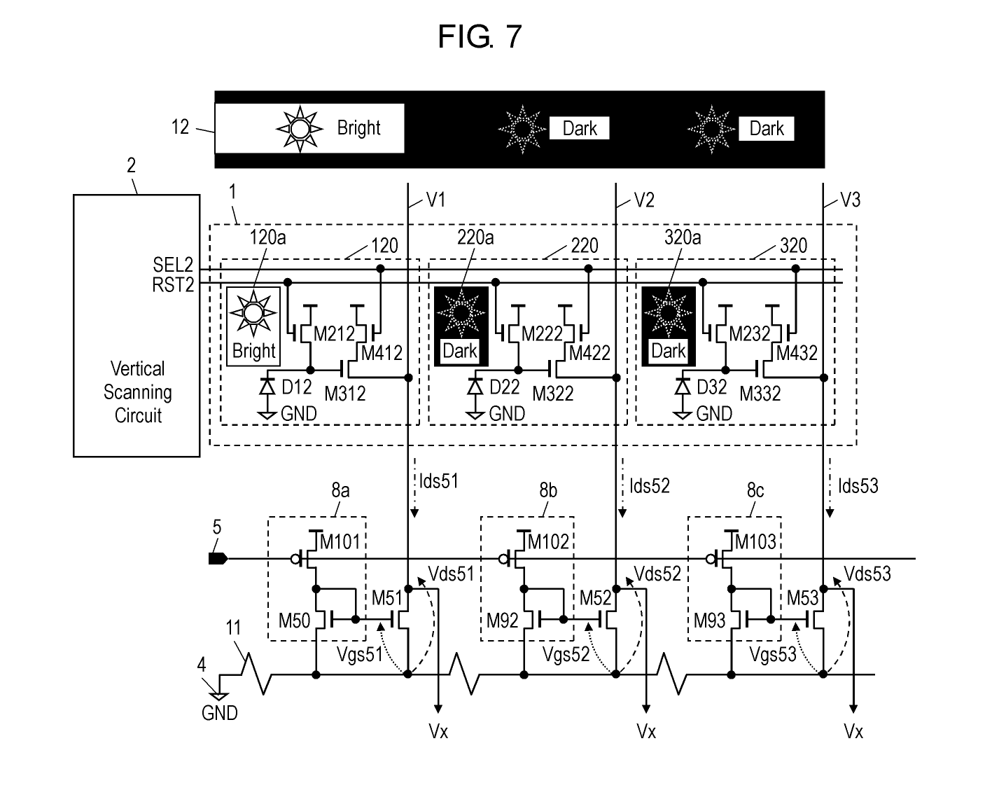

The above effects will further be described with specific examples. FIG. 7 is a view for explaining the specific example the operation of the solid-state image pickup device of the first exemplary embodiment. In FIG. 7, reference marks 120a, 220a, and 320a designate illustrations indicating brightness degrees of the light incident to pixel cells 120, 220, and 320 (the pixel cells of the second row of the solid-state image pickup device). At this point, in the illustrations, the bright light having the high illuminance is incident to pixel cell 120, and the light is not incident to pixel cells 220 and 320.

In FIG. 7, the reference mark Ids₅₁ designates the current passed through the load transistor M51, the reference mark Ids₅₂ designates the current passed through the load transistor M52, and the reference mark Ids₅₃ designates the current passed through the load transistor M53. The reference mark Vds₅₁ designates Vds of load transistor M51, the reference mark Vds₅₂ designates Vds of load transistor M52, and the reference mark Vds₅₃ designates Vds of load transistor M53.

In FIG. 7, the reference mark 11 designates the interconnection impedance of GND line 4, and the reference mark 12 designates a view illustrating the captured image output from the solid-state image pickup device when the light indicated by each of illustrations 120a, 220a, and 320a is incident to each of pixel cells 120 to 320.

In this case, because the signal charge is not generated in photodiodes D22 and D32 of pixel cells 220 and 320 to which the light is not incident, the signal voltages (Vx) read on vertical signal lines V2 and V3 become the maximum, and Vds₅₂ and Vds₅₃ reach a maximum value (V_{RST}) according to the signal voltages (Vx).

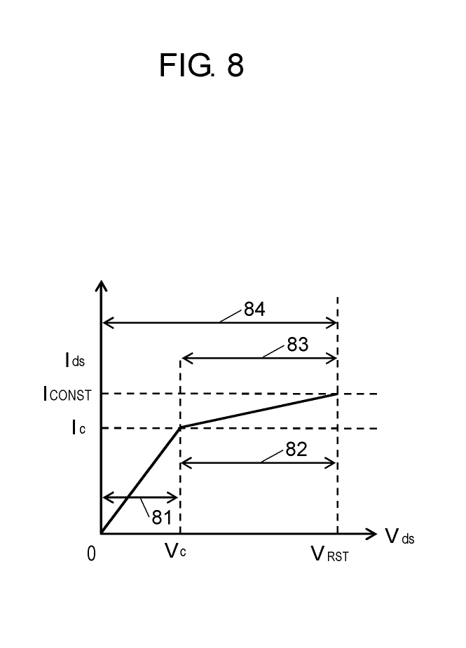

FIG. 8 is a view illustrating a correspondence relationship between Vds and a current Ids passed between the drain and the source of the load transistor. As illustrated in FIG. 8, when Vds exists within saturation region 82, as Vds is decreased from the maximum value V_{RST} to a boundary value (Vc) of the lower limit of the saturation region by the channel length modulation effect, Ids is smoothly decreased from I_{CONST} (the value of the current passed through the load transistor when Vds is V_{RST}) to Ic (the value of the current passed through the load transistor when Vds is Vc, Ic<I_{CONST}). When Vds is decreased lower than Vc to enter non-saturation region 81, Ids is rapidly decreased, the current is finally not passed (Ids=0), and the load transistor is turned off.

As the illuminance of the light incident to pixel cell 120 is enhanced, the signal voltage (Vx) is decreased, and Vds₅₁ is decreased. Therefore, Ids₅₁ is decreased from I_{CONST} because of the correspondence relationship of FIG. 8. For example, the current amount is decreased by up to the current amount corresponding to (I_{CONST}-Ic) when Vds₅₁ exists in the saturation region, and the current amount is decreased by up to the current amount corresponding to I_{CONST} when Vds₅₁ exists in the non-saturation region.

When Vds₅₁ is decreased, the amount of current flowing in GND line 4 is decreased compared with the case in which the light is not incident to pixel cell 120, and therefore the voltage drop amount is decreased on GND line 4.

However, reference current source circuits 8b and 8c are provided and connected to load transistors M52 and M53, respectively, and the currents having the substantially same magnitude as the constant current are passed through load transistors M52 and M53 through the reference current source circuits 8b and 8c. Therefore, even if the voltage drop amount is decreased on GND line 4, Vds₅₂ and Vds₅₃ are not decreased, and the captured images corresponding to pixel cells 220 and 320 can be prevented from becoming whitish as illustrated by the captured image 12 of FIG. 7.

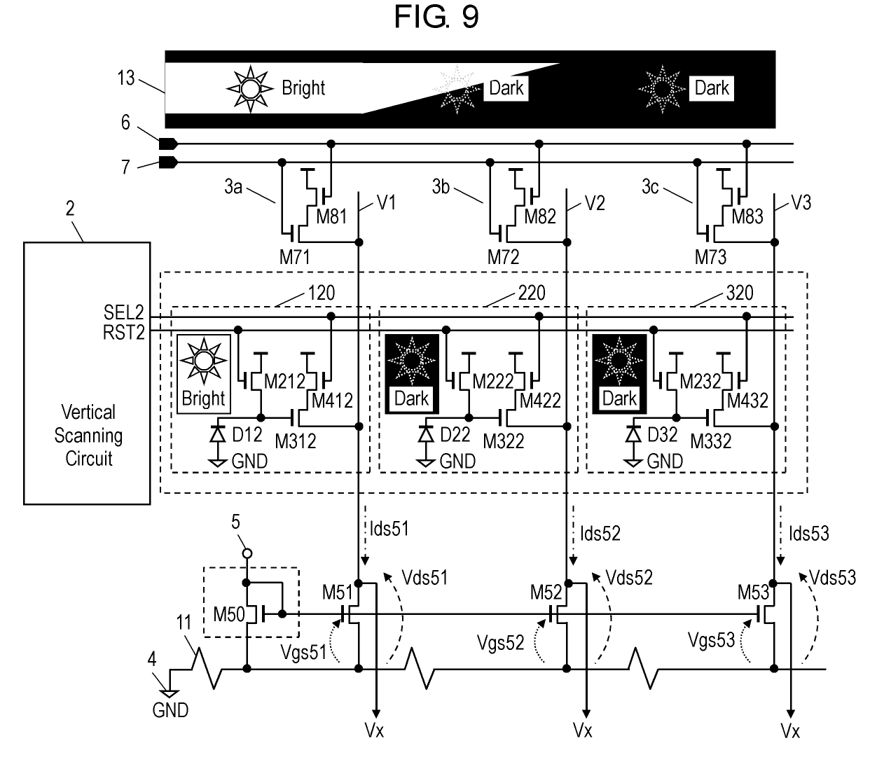

On the other hand, as illustrated in FIG. 9, unlike the solid-state image pickup device of the first exemplary embodiment, in a solid-state image pickup device according to a comparative example having a circuit configuration in which the distances between the connection point at which reference transistor M50 is connected to GND line 4 and the connection point at which each of load transistors M51 to M53 is connected to GND line 4 is not always disposed so as to become the neighborhood distance, when the spot light having the high illuminance is incident to pixel cell 120, the captured images corresponding to pixel cells 220 and 320 cannot completely be prevented from becoming whitish. The comparative example will be described below with reference to FIG. 9. In FIG. 9, the same component as that of FIG. 7 is designated by the same reference mark.

In FIG. 9, the reference mark 13 designates a view illustrating the captured image output from the solid-state image pickup device when the light indicated by each of illustrations 120a, 220a, and 320a is incident to each of pixel cells 120 to 320.

Similarly to the specific example of FIG. 7, as the illuminance of the light incident to pixel cell 120 is enhanced, the signal voltage (Vx) is decreased compared with the case in which the light is not incident to pixel cell 120, and Vds₅₁ is decreased. Therefore, Ids₅₁ is decreased from I_{CONST} because of the correspondence relationship of FIG. 8.

When Ids₅₁ is decreased, the amount of current flowing in GND line 4 is decreased compared with the case in which the light is not incident to pixel cell 120, and therefore the voltage drop amount is decreased on GND line 4.

As illustrated in FIG. 9, in a solid-state image pickup device of the comparative example, because clipping circuits 3a to 3c are provided, Vds₅₁ is set so as not to become Vc or less even if the illuminance of the light incident to pixel cell 120 is enhanced. However, because clipping circuits 3a to 3c do not function in the saturation region, Ids₅₁ is decreased in the saturation region by the channel length modulation effect as the illuminance of pixel cell 120 is enhanced, and therefore the voltage drop amount is decreased on GND line 4. Vds₅₂ and Vds₅₃ are decreased by the influence of the decrease of the voltage drop amount for the same reason as the case in which the load transistor is turned off, the images corresponding to pixel cells 220 and 320 become whitish.

Specifically, in the case of a small illuminance difference between pixel cells 220 and 320 due to the low illuminance of pixel cell 120, because the decrease amount of Ids₅₁ by the channel length modulation effect can be omitted, the voltage drop amounts of GND line 4 is hardly decreased. However, the decrease amount of Ids₅₁ by the channel length modulation effect cannot be omitted as the illuminance of pixel cell 120 is enhanced. Therefore, the voltage drop amounts of GND line 4 is decreased, Vds₅₂ and Vds₅₃ are decreased, and the images corresponding to pixel cells 220 and 320 become whitish.

On the other hand, as described above, in the solid-state image pickup device of the first exemplary embodiment, because Vds₅₂ and Vds₅₃ are not decreased even if Ids₅₁ is decreased in the saturation region, the images corresponding to pixel cells 220 and 320 can be prevented from becoming whitish in the saturation region. The solid-state image pickup device of the first exemplary embodiment has a superior to the solid-state image pickup device of the comparative example in this point.

In the solid-state image pickup device of the first exemplary embodiment, clipping circuits 3a to 3c that set Vds such that Vds does not become Vc or less are not provided unlike the solid-state image pickup device of the comparative example of FIG. 9. Therefore, the dynamic range of the detectable signal voltage can be taken wider as illustrated by the reference mark 84 of FIG. 8, and the illuminance difference can be detected in the range even in which the signal voltage is Vc or less.

Accordingly, the solid-state image pickup device of the first exemplary embodiment is superior to the solid-state image pickup device of the comparative example in the dynamic range of the detectable signal voltage, namely, the detection sensitivity on the high-illuminance side is excellent (see FIG. 8, the dynamic range 83 of the solid-state image pickup device of the comparative example).

### Second Exemplary Embodiment

A solid-state image pickup device according to a second exemplary embodiment differs from the solid-state image pickup device of the first exemplary embodiment in that the connection of the reference current source circuit and the load transistor corresponding to the reference current source circuit is switched between the turn-on and the turn-off. Therefore, a use frequency of the reference current source circuit having large power consumption is controlled, and the reference current source can be controlled in driving the solid-state image pickup device such that the power consumption amount is not increased by the unnecessary, frequently use of the reference current source circuit having the large power consumption. The point different from the solid-state image pickup device of the first exemplary embodiment will mainly be described below.

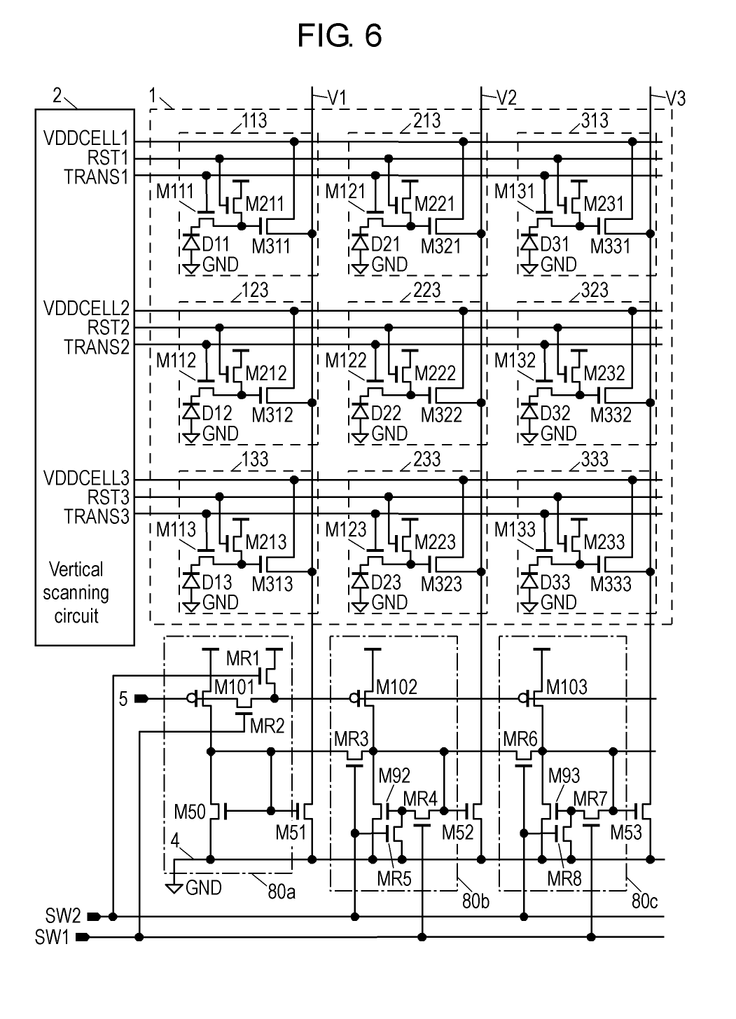

FIG. 6 is a block diagram illustrating a configuration of the solid-state image pickup device of the second exemplary embodiment. In FIG. 6, the same component as the solid-state image pickup device of the first exemplary embodiment is designated by the same reference mark.

In the configuration of the solid-state image pickup device of the second exemplary embodiment, a transfer transistor (M111 to M133) is provided between the cathode side of the photodiode and the gate of the amplification transistor in each of pixel cells 113 to 333, and the selection transistor of each pixel cell is eliminated.

The drains of the amplification transistors (M311 to M313, M321 to M323, and M331 to M333) of the pixel cells of each row are commonly connected to the corresponding row selection line of in row selection lines VDDCELL1 to VDDCELL3 connected to vertical scanning circuit 2.

The gates of the transfer transistors (M111 to M113, M121 to M123, and M131 to M133) of the pixel cells of each row are commonly connected to the corresponding row selection line of in row selection lines TRANS1 to TRANS3 connected to vertical scanning circuit 2.

The solid-state image pickup device of the second exemplary embodiment include reference current source circuits 80a to 80c instead of reference current source circuits 8a to 8c. Reference current source circuit 80a includes PMOS transistor M101, switching transistor MR1, switching transistor MR2, and reference transistor M50. Reference current source circuit 80a and load transistor M51 constitute a current mirror. PMOS transistor M101 receives a constant voltage from voltage input terminal 5 to the gate to pass a constant current through reference transistor M50. In PMOS transistor M101, the source is connected to the power supply line, the gate is connected to the voltage input terminal 5, and the drain is connected to the gate and the drain of reference transistor M50. In switching transistor MR1, the source is connected to the drain of switching transistor MR2, the gate is connected to control signal line SW2, and the drain is connected to the power supply line. In switching transistor MR2, the source is connected to voltage input terminal 5, the gate is connected to control signal line SW1, and the drain is connected to the source of switching transistor MR1. In reference transistor M50, the source is connected to GND line 4, the gate is connected to the gate of load transistor M51 and the drain of PMOS transistor M101, and the drain is connected to the drain of PMOS transistor M101.

Reference transistor M50 and load transistor M51 are disposed such that the distance between connection points in which reference transistor M50 and load transistor M51 are connected to GND line 4 becomes the neighborhood distance.

Because each of reference current source circuits 80b and 80c includes the same components, reference current source circuit 80b will mainly be described below. Reference current source circuit 80b includes PMOS transistor M102, switching transistor MR3, reference transistor M92, switching transistor MR5, and switching transistor MR4. Reference current source circuit 80b and load transistor M52 constitute a current mirror. PMOS transistor M102 receives a constant voltage from voltage input terminal 5 to the gate through switching transistor MR2 to pass a constant current through reference transistor M92. In PMOS transistor M102, the source is connected to the constant voltage source, the gate is connected to the source of switching transistor MR1 of reference current source circuit 80a and the drain of switching transistor MR2, and the drain is connected to the drain of reference transistor M92. In switching transistor MR3, the source is connected to the gate of reference transistor M50, the gate is connected to control signal line SW2, and the drain is connected to the drain of reference transistor M92. In reference transistor M92, the source is connected to GND line 4, the gate is connected to the drain of switching transistor MR5, and the drain is connected to the drain of PMOS transistor M102. In switching transistor MR5, the source is connected to GND line 4, the gate is connected to control signal line SW2, and the drain is connected to the gate of reference transistor M92. In switching transistor MR4, the source is connected to the drain of switching transistor MR5, the gate is connected to control signal line SW1, and the drain is connected to the drain of reference transistor M92.

Reference transistor M92 and load transistor M52 are disposed such that the distance between connection points in which reference transistor M92 and load transistor M52 are connected to GND line 4 becomes the neighborhood distance.

Reference current source circuit 80c includes the same component as reference current source circuit 80b, each component is connected similarly to the case of reference current source circuit 80b, and reference current source circuit 80c and load transistor M53 constitute a current mirror. Reference transistor M93 and load transistor M53 of reference current source circuit 80c are disposed such that the distance between connection points in which reference transistor M93 and load transistor M53 are connected to GND line 4 becomes the neighborhood distance.

Switching transistor MR2, switching transistor MR4, and switching transistor MR7 whose gates are connected to control signal line SW1 are turned on when control signal line SW1 becomes an on-state. When switching transistor MR2 is turned on, voltage input terminal 5 and the gates of PMOS transistor M102 and PMOS transistor M103 are connected to supply the constant voltage from voltage input terminal 5 to the gates of PMOS transistor M102 and PMOS transistor M103.

The gate of reference transistor M92 and the gate of load transistor M52 are connected by turning on switching transistor MR4, and the gate of reference transistor M93 and the gate of load transistor M53 are connected by turning on switching transistor MR7.

When control signal line SW2 becomes an off-state while control signal line SW1 is in the on-state, switching transistor MR1, switching transistor MR3, switching transistor MR5, switching transistor MR6, and switching transistor MR8 whose gates are connected to control signal line SW2 are turned off, reference transistor M50 and load transistor M52 are disconnected, and reference transistor M50 and load transistor M53 are disconnected.

As described above, when control signal line SW1 set to the on-state while control signal line SW2 is set to the off-state, similarly to the first exemplary embodiment, the current mirrors are formed between reference current source circuit 80a and load transistor M51, between reference current source circuit 80b and load transistor M52, and between reference current source circuit 80c and load transistor M53, and the constant current can be supplied to the corresponding load transistor from each reference current source circuit.

On the other hand, when control signal line SW1 becomes the off-state, switching transistor MR2, switching transistor MR4, and switching transistor MR7 whose gates are connected to control signal line SW1 are turned off, voltage input terminal 5 and the gates of PMOS transistor M102 and PMOS transistor M103 are disconnected to stop the supply of the constant voltage from voltage input terminal 5 to each of the gates of PMOS transistor M102 and PMOS transistor M103, and the gates of reference transistor M92 and load transistor M52 are disconnected while the gates of reference transistor M93 and load transistor M53 are disconnected.

When control signal line SW2 becomes the on-state while control signal line SW1 is in the off-state, switching transistor MR1, switching transistor MR3, switching transistor MR5, switching transistor MR6, and switching transistor MR8 whose gates are connected to control signal line SW2 are turned on, the gates of reference transistor M50 and load transistor M52 are connected while the gates of reference transistor M50 and switching transistor M53 are connected, and the voltage is supplied from the power supply line through switching transistor MR1 to increase the gate voltages of PMOS transistor M102 and PMOS transistor M103, thereby turning off PMOS transistor M102 and PMOS transistor M103.

As described above, when control signal line SW1 set to the off-state while control signal line SW2 is set to the on-state, the current mirrors are disconnected between reference current source circuit 80b and load transistor M52 and between reference current source circuit 80c and load transistor M53, the current mirrors are formed between reference current source circuit 80a and load transistors M51 to M53 similarly to the conventional art, and the constant current can be supplied to load transistors M51 to M53 from reference current source circuit 80a.

Accordingly, control signal line SW1 and control signal line SW2 are switched between the turn-on and the turn-off, which allows the method for supplying the constant current to each of load transistors M51 to M53 to be switched between the supply method of the first exemplary embodiment and the supply method of the conventional art.

For example, a detection unit that detects illuminance of a subject is provided in the solid-state image pickup device, and the constant-current supplying method may be switched according to an illuminance detection result of the detection unit.

Specifically, the control may be performed such that the constant-current supplying method is switched to the supply method of the conventional art under the high-illuminance condition that the whitish band by the spot light is inconspicuous because of the high illuminance of the subject, and such that the constant-current supplying method is switched to the supply method of the first exemplary embodiment under the low-illuminance condition that the whitish band by the spot light is conspicuous because of the low illuminance of the subject.

Therefore, under the high-illuminance condition that the whitish band by the spot light is inconspicuous, the constant current is supplied by the supply method of the conventional art in which the power consumption amount is reduced instead of the supply method of the first exemplary embodiment in which the power consumption amount is large, and the power consumption amount of the solid-state image pickup device can be reduced.

Although the exemplary embodiments of the invention are described above, the invention is not limited to the above exemplary embodiment. Various modifications of the exemplary embodiments and combinations of the components of the exemplary embodiments are also included in the invention as long as the modifications and combinations do not depart from the scope of the invention. For example, the following modifications can be made.

(1) In the solid-state image pickup device of the first exemplary embodiment, the transfer transistor may be provided between the cathode side of the photodiode and the gate of the amplification transistor of each pixel cell. Specifically, the following configuration may be adopted.

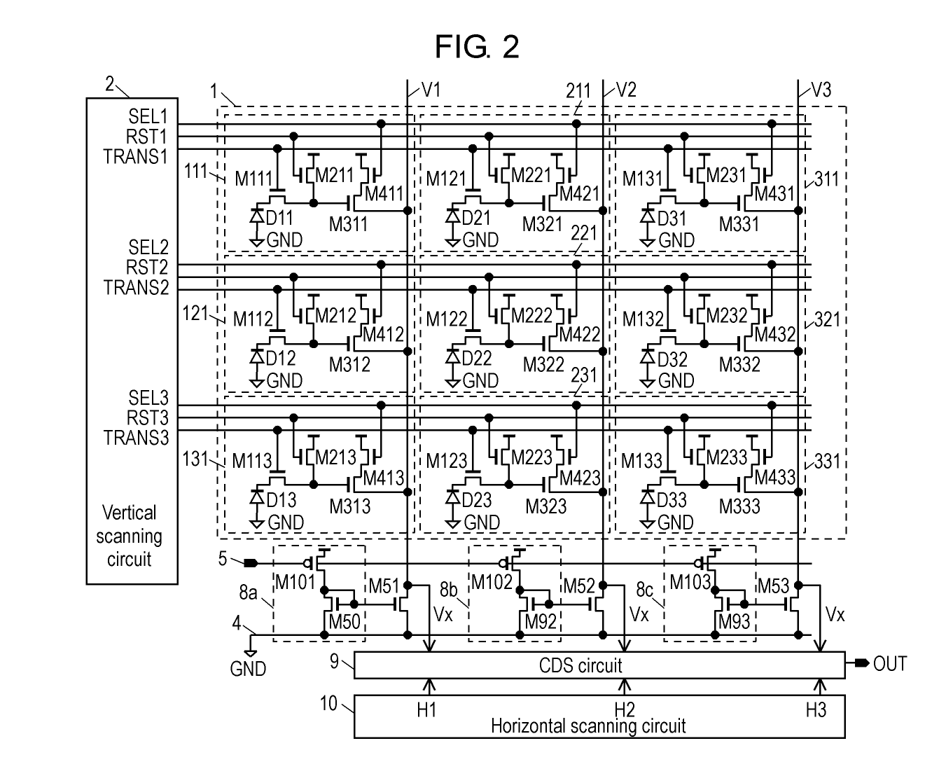

FIG. 2 is a block diagram illustrating a configuration of a solid-state image pickup device according to a first modification of the first exemplary embodiment. As illustrated in FIG. 2, in the first modification, transfer transistors M111 to M133 are provided between the cathode sides of the photodiodes and the gates of the amplification transistors in pixel cells 111 to 331, respectively.

In each of transfer transistors M111 to M133, the source is connected to the amplification transistor of the pixel cell including the transfer transistor in question, the gate is connected to the row selection line corresponding to the row to which the pixel cell including the gate belongs in row selection lines TRANS1 to TRANS3 connected to vertical scanning circuit 2, and the drain is connected to the cathode side of the photodiode of the pixel cell including the transfer transistor.

When the row selection line of each row is selected, each of the transfer transistors of the pixel cells of the row transfers the signal charge accumulated in the photodiode of the pixel cell to the amplification transistor of the pixel cell.

(2) In the solid-state image pickup device of the first modification, the drain of the amplification transistor of each pixel cell may be configured to be directly connected to the power supply. Specifically, the following configuration may be adopted.

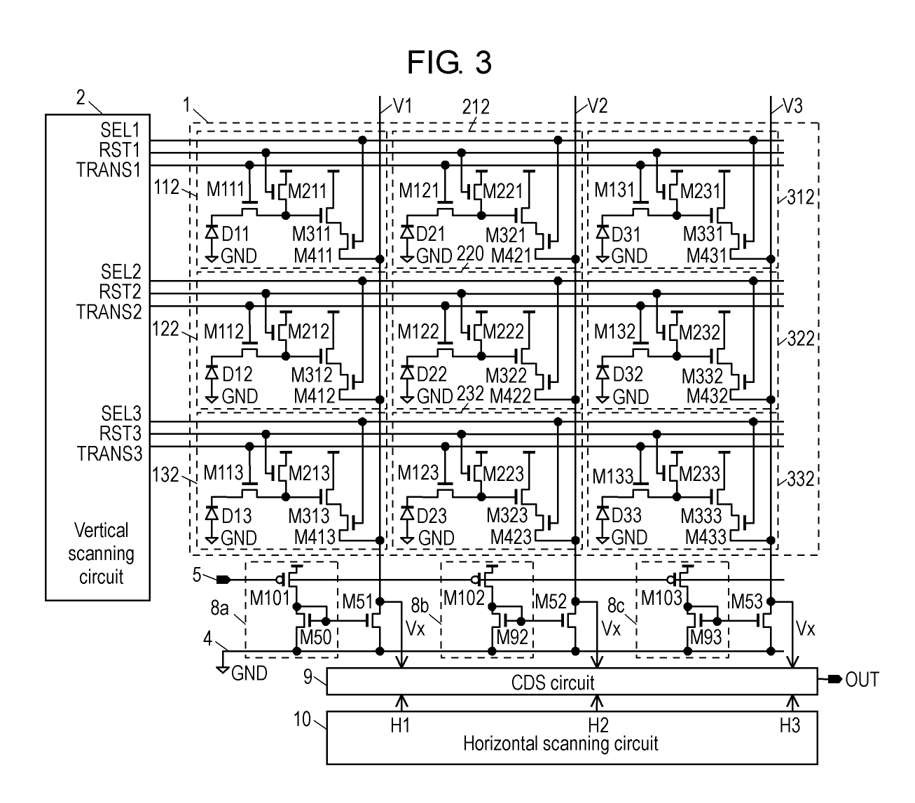

FIG. 3 is a block diagram illustrating a configuration of a solid-state image pickup device according to a second modification. As illustrated in FIG. 3, in the amplification transistor of each of the pixel cells 112 to 332 of the second modification, the source is connected to the drain of the selection transistor of the pixel cell including the amplification transistor in question and to the corresponding vertical signal line through the selection transistor, the gate is connected to the source of the transfer transistor of the pixel cell including the amplification transistor in question and to the source of the reset transistor of the pixel cell including the amplification transistor in question, and the drain is directly connected to the power supply.

(3) In the solid-state image pickup device of the second modification, the selection transistor of each pixel cell may be eliminated. Specifically, the following configuration may be adopted.

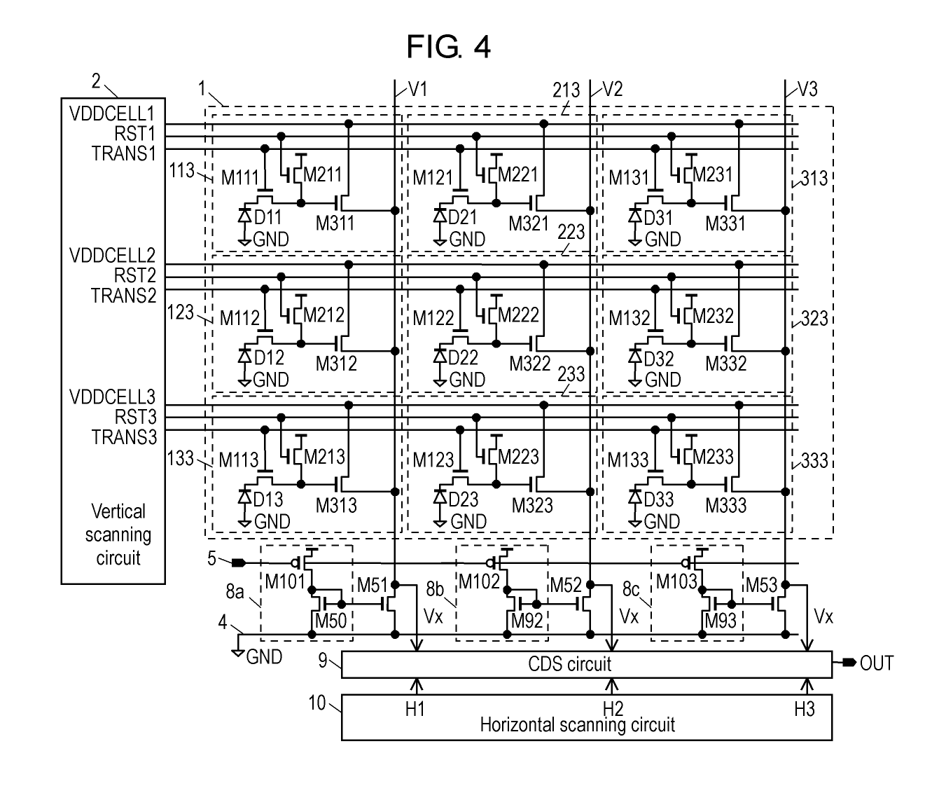

FIG. 4 is a block diagram illustrating a configuration of a solid-state image pickup device according to a third modification. As illustrated in FIG. 4, in the amplification transistor of each of the pixel cells 113 to 333 of the third modification, the source is directly connected to the corresponding vertical signal line, the gate is connected to the source of the transfer transistor of the pixel cell including the amplification transistor in question and to the source of the reset transistor of the pixel cell including the amplification transistor in question, and the drain is connected to the row selection line corresponding to the row to which the pixel cell including the drain belongs in row selection lines VDDCELL1 to VDDCELL3 connected to vertical scanning circuit 2.

(4) In the solid-state image pickup devices of the first exemplary embodiment and the second and third modifications, the reference current source circuit that constitutes the current mirror in conjunction with the load transistor is provided in each load transistor connected to the vertical signal line. However, it is not always necessary that the reference current source circuit be provided in each load transistor connected to the vertical signal line, but the reference current source circuits may be provided in at least two positions.

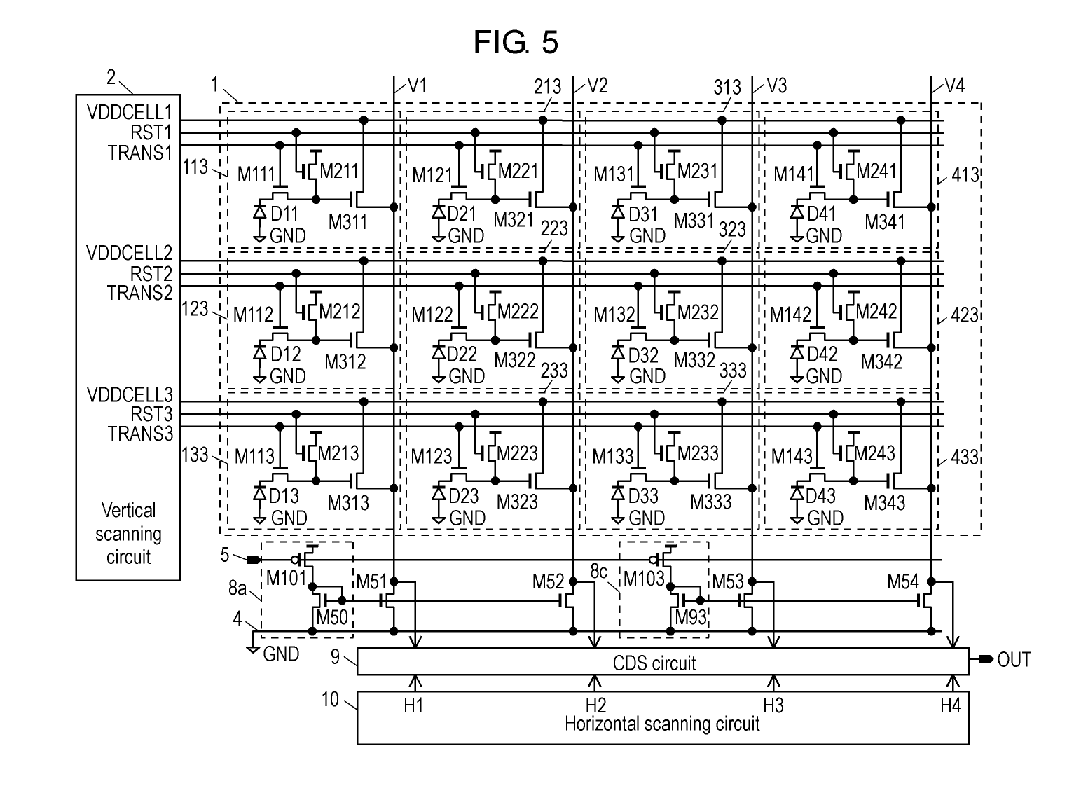

For example, the reference current source circuit that constitutes the current mirror in conjunction with the load transistor connected to the vertical signal line may be provided in each predetermined number of vertical signal lines. The predetermined number may be an integer of 2 or more. FIG. 5 illustrates a specific example of a configuration of a solid-state image pickup device in the case of the predetermined number of 2. As illustrated in FIG. 5, in the solid-state image pickup device, the reference current source circuit (8a and 8c of FIG. 5) is provided in each two vertical signal lines (V1 and V2, and V3 and V4 of FIG. 5).

As described above, when the number of reference current source circuits is set to a proper number, the number of semiconductor elements can be decreased compared with the case in which the reference current source circuits are provided for all the load transistors, and therefore a layout area of the solid-state image pickup device can be reduced.

The invention can be applied to the solid-state image pickup device used for an image input apparatus that is typified by the camcorder, the digital camera, a camera-equipped mobile phone, and the like.

What is claimed is:

1. A solid-state image pickup device comprising:
a plurality of pixel cells that are two-dimensionally arrayed, the pixel cell including a photoelectric conversion element that generates a signal charge according to a light receiving amount and an amplification transistor that amplifies and outputs the generated signal charge as a signal voltage;
a plurality of vertical signal lines to each of which outputs of the pixel cells of each identical column are commonly connected;
at least two reference current source circuits that are connected to a constant-current source, the reference current source circuit including a reference transistor that receives supply of a constant current from the constant-current source; and
a plurality of load transistors each of which is connected to the vertical signal line of each column, a gate of each load transistor being connected to a gate of the reference transistor included in one of the reference current source circuits, the load transistor constituting a current mirror in conjunction with the reference transistor, wherein
the load transistor and the reference transistor, which are connected to the vertical signal line of each column, are grounded to a common ground line in different positions, and,
in at least two position, a distance between connection points at which the load transistor and the reference transistor, which constitute the current mirror, are grounded to the ground line is shorter than a distance between connection points of the load transistors adjacent to each other on the ground line.

2. The solid-state image pickup device according to claim 1, wherein the reference current source circuit is provided in each load transistor connected to the vertical signal line of each column, and a distance between connection points at which the reference transistor included in the reference current source circuit and the load transistor are grounded to the ground line is shorter than the distance between the connection points of the load transistors adjacent to each other on the ground line.

3. The solid-state image pickup device according to claim 2, wherein
a power feeding selector switch that switches between a turn-on and a turn-off of power feeding is provided in a predetermined reference current source circuit of the reference current source circuits in order to pass a constant current to each of the reference transistors of the reference current source circuits except the predetermined reference current source circuit,
a first selector switch and a second selector switch are provided in each of the reference current source circuits except the predetermined reference current source circuit, the first selector switch switching between a turn-on and a turn-off of connection of the gate of the reference transistor of the reference current source circuit and the gate of the load transistor that constitutes the current mirror in conjunction with the reference transistor, the second switch switching between a turn-on and a turn-off of connection of the gate of the load transistor and the gate of the reference transistor of the predetermined reference current source circuit,
the solid-state image pickup device comprises: a first control signal line that is commonly connected to the power feeding selector switch and the first selector switches to turn on or off all the power feeding selector switch and the first selector switches; and
a second control signal line that is commonly connected to the second selector switches to turn on or off the second selector switches, and
the switching can be performed in all the selector switches using the first and second control signal lines.

4. The solid-state image pickup device according to claim 1, wherein
the reference current source circuit is provided in each predetermined number of vertical signal lines with respect to the load transistor connected to the vertical signal line, and the distance between the connection points at which the reference transistor included in the reference current source circuit and the load transistor are grounded to the ground line is shorter than the distance between the connection points of the load transistors adjacent to each other on the ground line.

5. A solid-state image pickup device comprising:
a plurality of pixel cells that are two-dimensionally arrayed, the pixel cell including a photoelectric conversion element that generates a signal charge according to a light receiving amount and an amplification transistor that amplifies and outputs the generated signal charge as a signal voltage;
a plurality of vertical signal lines to each of which outputs of the pixel cells of each identical column are commonly connected;
at least two reference current source circuits that are connected to a constant-current source, the reference current source circuit including a reference transistor that receives supply of a constant current from the constant-current source; and
a plurality of load transistors each of which is connected to the vertical signal line of each column, a gate of each load transistor being connected to a gate of the reference transistor included in one of the reference current source circuits, the load transistor constituting a current mirror in conjunction with the reference transistor, wherein
the load transistor and the reference transistor, which are connected to the vertical signal line of each column, are grounded to a common ground line in different positions.

6. The solid-state image pickup device according to claim 5, wherein
a gate of the one of the plurality of load transistors is connected to a gate of a reference transistor in the one of the reference current source circuits, and a gate of the another one of the plurality of load transistors is connected a gate of a reference transistor in the another one of the reference current source circuits.
